(19) United States
(12) Patent Application Publication
(10) Pub. No.: US 2015/0002922 A1
(43) Pub. Date: Jan. 1, 2015

(54) SELF-AUTOMATIC GAIN CONTROL DISTRIBUTED RAMAN FIBER AMPLIFIER AND AUTOMATIC GAIN CONTROL METHOD

(71) Applicant: LiComm Co., Ltd., Yongin-Si (KR)

(72) Inventors: Sung Jun KIM, Suwon-si (KR); Jeong Mee KIM, Suwon-si (KR); Soo Young YOON, Yongin-si (KR); Meong Kyu CHOI, Suwon-si (KR); Woon Byung CHAE, Suwon-si (KR)

(21) Appl. No.: 14/315,850

(22) Filed: Jun. 26, 2014

(30) Foreign Application Priority Data
Jun. 27, 2013 (KR) 10-2013-0074145

(51) Int. Cl. H01S 3/30

(52) U.S. Cl. CPC H01S 3/302
USPC 359/334

(57) ABSTRACT

Disclosed is a self-automatic gain control distributed Raman fiber amplifier, in which a signal is transmitted to a self-AGC monitor and a PD via a pump/signal combiner through a transmission fiber and passes through an RFA control circuit, a self-AGC firmware, and an ASCII communication unit and an Raman pump laser module communicates with the RFA control circuit and transmits the signal to the pump/signal combiner.

### BACKGROUND OF THE INVENTION

1. Field of the Invention

The present invention relates to a self-automatic gain control distributed Raman fiber amplifier and an automatic gain control method, and more particularly, to a self-automatic gain control distributed Raman fiber amplifier capable of performing automatic self control for controlling a target Raman gain and a gain tilt, performing automatic self estimation of a Raman gain and tilt, and performing self compensation of errors of the Raman gain and the gain tilt which are caused by a cascade of several amplifiers.

2. Description of the Related Art

FIGS. 1 to 4 are diagrams for describing a basic configuration and a principle of distributed Raman fiber amplifiers (DRFAs) used in the related art. Referring to FIG. 1, Raman pumping light of a Raman pumping laser module 30 is incident on a transmission fiber 10 through a WDM 20. The incident pumping light brings about Raman effect and performs amplification of an optical signal using the Raman effect.

Referring to FIG. 2, a basic control method of the DRFA of the related art includes monitoring laser current or intensity of a Raman pumping laser module 30 using a control device 90 and directly controlling, by a DRFA user, the laser current or intensity of the Raman pumping laser module 30 so as to maintain the laser current or intensity at a target value.

Another method for controlling the DRFA of the related art is illustrated in FIG. 3. Referring to FIG. 3, a signal is transmitted to a control device 90 while monitoring a Raman pumping laser module 30 of the DRFA using a photodetector (PD) 40 which is connected to a tap 50 on a transmission fiber 10. The DRFA user uses the control device 90 to control the Raman pumping laser intensity incident on the transmission fiber 10 through a WDM 20 coupler based on a DRFA monitoring value so as to make the Raman pumping laser intensity reach a Raman gain target value.

Another method for controlling the DRFA of the related art is illustrated in FIG. 4. Referring to FIG. 4, a Raman amplification controller 80 controls a Raman pumping laser module 30 to make intensity of a signal output from the DRFA through a splitter 60 and a signal monitor 70 reach the Raman gain target value of the DRFA user.

That is, the Raman amplification controller 80 monitors the signal output from the DRFA and controls the Raman pumping laser module 30 to make the output signal constant.

However, the distributed Raman fiber amplifier of the related art needs to control total pumping laser power according to a type of the transmission fiber (see FIG. 5).

In addition, the distributed Raman fiber amplifier of the related art needs to control the total pumping laser power according to a length of the transmission fiber (see FIG. 6). Further, the Raman gain may be changed as a loss of the transmission fiber is changed in the distributed Raman fiber amplifier of the related art (see FIG. 7).

Further, in order to minimize gain flatness, the distributed Raman fiber amplifier of the related art needs to optimize a pump power ratio of the Raman pumping laser (see FIG. 8).

Furthermore, the loss of the fiber may occur in the distributed Raman fiber amplifier of the related art due to reconstruction, restructuring, natural disaster, and aging of the fiber.

### SUMMARY OF THE INVENTION

Accordingly, it is an object of the present invention to provide a self-automatic gain control distributed Raman fiber amplifier which performs automatic self control for maintaining a target Raman gain and a gain tilt.

Another object of the present invention is to provide a self-automatic gain control distributed Raman fiber amplifier which performs automatic self estimation of a Raman gain and tilt.

Another object of the present invention is to provide a self-automatic gain control distributed Raman fiber amplifier which performs self compensation of errors of a Raman gain and a gain tilt which are caused by a cascade of amplifiers.

Another object of the present invention is to provide an automatic gain control method using a self-automatic gain control distributed Raman fiber amplifier.

According to an aspect of the present invention, there is provided a self-automatic gain control distributed Raman fiber amplifier, including: a Raman pump laser module configured to generate pumping light to compensate for a signal loss generated from a transmission fiber; a pump/signal combiner configured to input the pumping light to the transmission fiber; a self-AGC monitor configured to monitor a self-AGC state and convert an optical signal into an electrical signal to be output; an RFA control circuit configured to generate an electrical signal for controlling the Raman pump laser module using the electrical signal output from the self-AGC monitor; a self-AGC firmware configured to generate a target pump laser value using a monitor signal received through the RFA control circuit and transmit a control signal to the RFA control circuit; and an ASCII communication unit configured to transmit or receive monitor and control information to or from an external user.

Preferably, the self-AGC monitor includes a first filter, a second filter, and a tap coupler, which are connected to a BPD, an RPD, and an OPD, respectively, the Raman pump laser module includes a B-pump, an R-pump, and a pump combiner, the RFA control circuit includes a pump LD bias & TEC control circuit, a low power monitoring circuit, and a wide dynamic range monitoring circuit, and the self-AGC firmware includes a pump LD APC algorithm, an EDFA ASE compensate algorithm, and a total power conversion software.

Preferably, the first filter is configured to filter some wavelengths in a short wavelength band which does not overlap with a signal light wavelength, and the some wavelengths filtered by the first filter is in a wavelength band of 1515 to 1525 nm.

Preferably, the second filter is configured to filter some wavelengths in a long wavelength band which does not overlap with a signal light wavelength, and the some wavelengths filtered by the second filter is in a wavelength band of 1567 to 1575 nm.

According to another aspect of the present invention, there is provided an automatic gain control method for a self-automatic gain control distributed Raman fiber amplifier, including: setting a Raman gain of a user; checking safety (input alarm and reflection alarm); analyzing, by the pumping LD, a fiber type; determining the fiber type and an EDFA ASE; calculating reference RPD and BPD values; comparing the reference RPD and BPD values with self-AGC monitor reading values (BPD, RPD, and OPD) which are currently being operated to determine whether both values coincide with each other; controlling a B-pump, and determining whether the reference BPD value coincides with the self-AGC monitor value BPD which is currently being operated; and controlling an R-pump, and determining whether the reference RPD value coincides with the self-AGC monitor value RPD.

Preferably, the determining of the fiber type and the EDFA ASE includes: starting application of an initial bias; determining n fiber types by performing the comparison of n target OPD reading values with the current OPD reading value n times; and completing the determining of the fiber type and the calculating the reference RPD and BPD.

According to the self-automatic gain control distributed Raman fiber amplifier and the automatic gain control method of the present invention having the above-described configuration, it is possible to perform the automatic self control for maintaining the target gain and tilt.

In addition, it is possible to perform the automatic self estimation of the Raman gain and tilt.

Further, it is possible to perform the self compensation of the errors of the Raman gain and tilt which are caused by the cascade of amplifiers.

### BRIEF DESCRIPTION OF THE DRAWINGS

The above and other objects, features and advantages of the present invention will become apparent from the following description of preferred embodiments given in conjunction with the accompanying drawings, in which:

FIGS. 1 to 4 are diagrams illustrating a basic configuration of distributed Raman fiber amplifiers (DRFAs) of the related art;

FIGS. 5 to 8 are graphs illustrating a problem of the distributed Raman fiber amplifiers (DRFAs) of the related art;

FIG. 9 is a diagram illustrating a configuration of a self-automatic gain control distributed Raman fiber amplifier according to an embodiment of the present invention;

FIG. 10 is a block diagram illustrating a configuration of the self-automatic gain control distributed Raman fiber amplifier according to the embodiment of the present invention;

FIG. 11 is a diagram illustrating a process of compensating for an automatic gain control error using the self-automatic gain control distributed Raman fiber amplifier according to the embodiment of the present invention;

FIG. 12 is a diagram illustrating the process of FIG. 11 by Formula;

FIG. 13 is a flow chart for describing a compensate algorithm of the self-automatic gain control distributed Raman fiber amplifier according to the embodiment of the present invention; and

FIG. 14 is a flow chart for describing a process for determining a fiber type of the self-automatic gain control distributed Raman fiber amplifier according to the embodiment of the present invention.

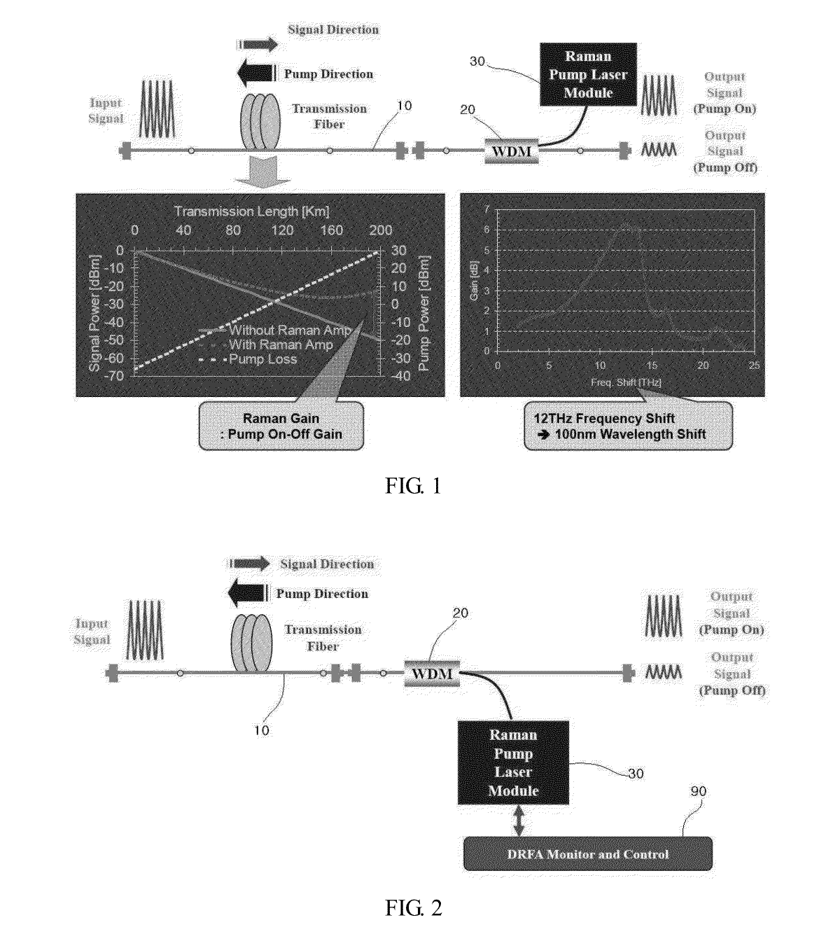

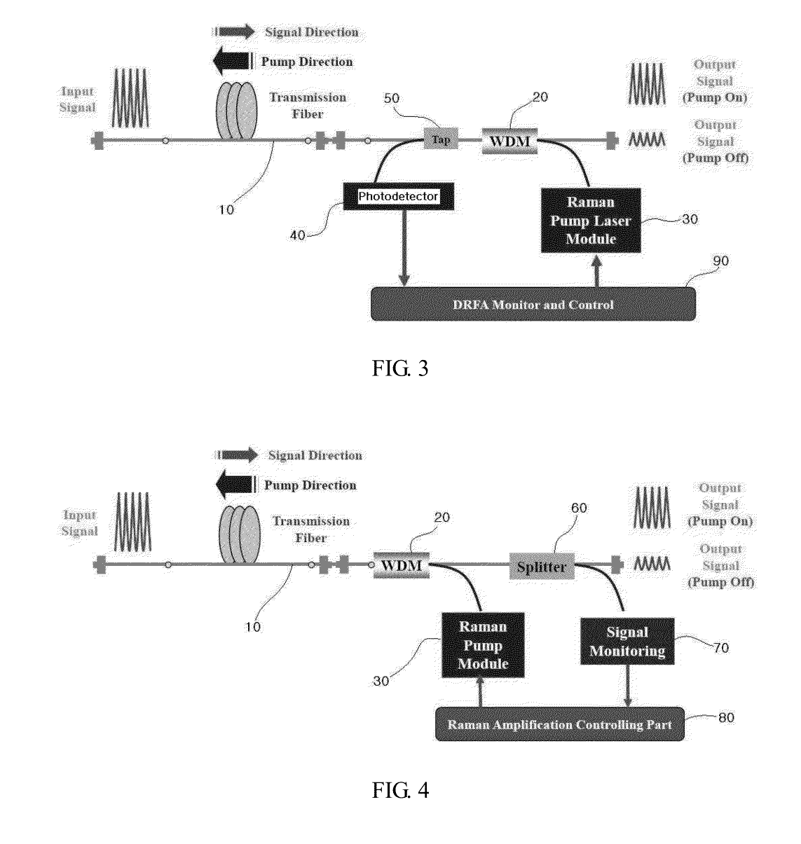

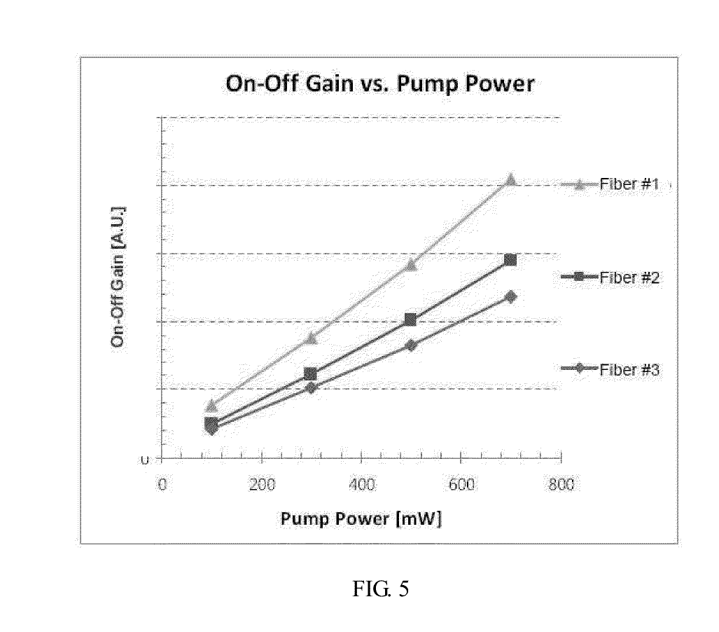

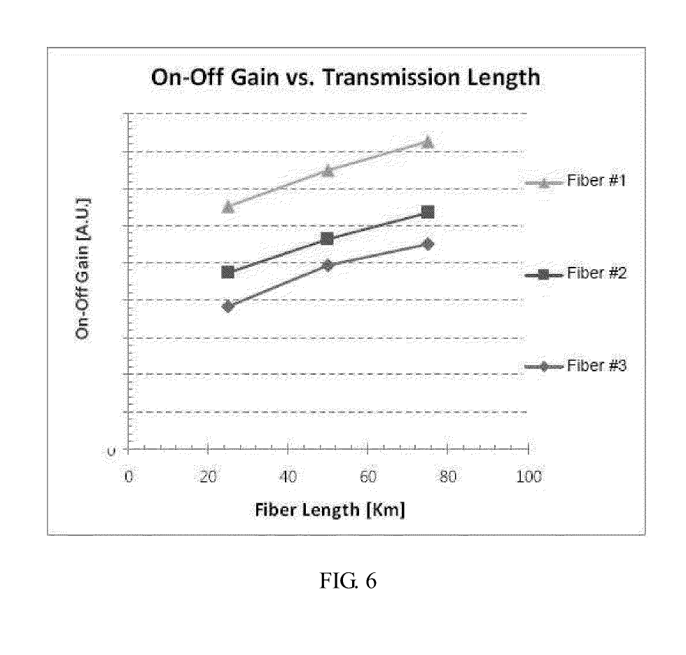

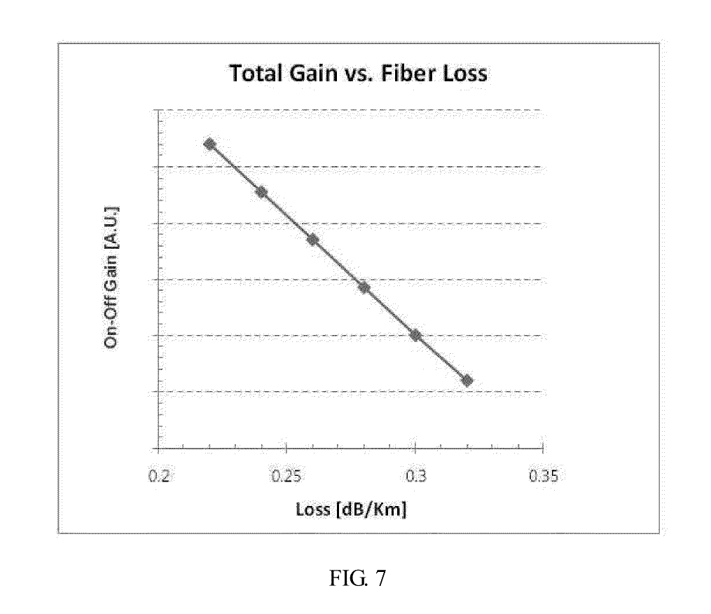

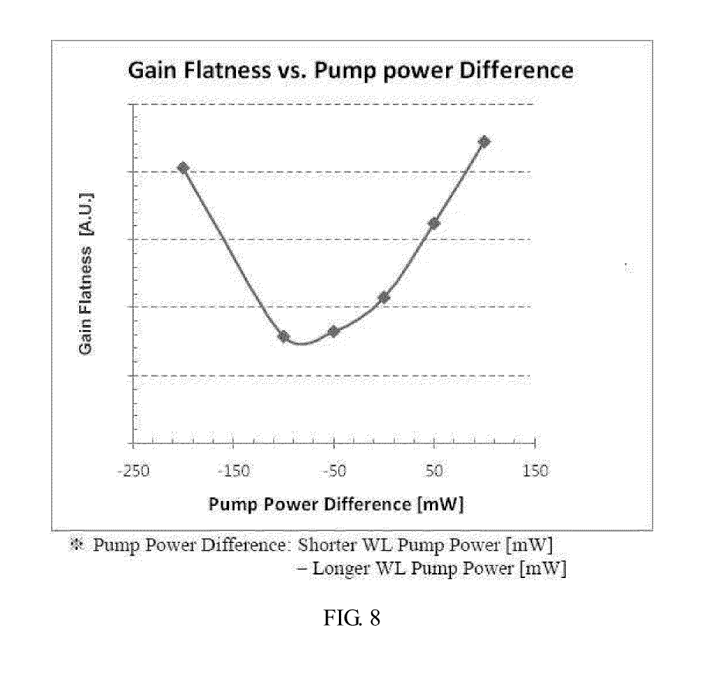

### DETAILED DESCRIPTION OF THE INVENTION

Hereinafter, a self-automatic gain control (self-AGC) distributed Raman fiber amplifier and an automatic gain control method according to an embodiment of the present invention will be described with reference to the accompanying drawings.

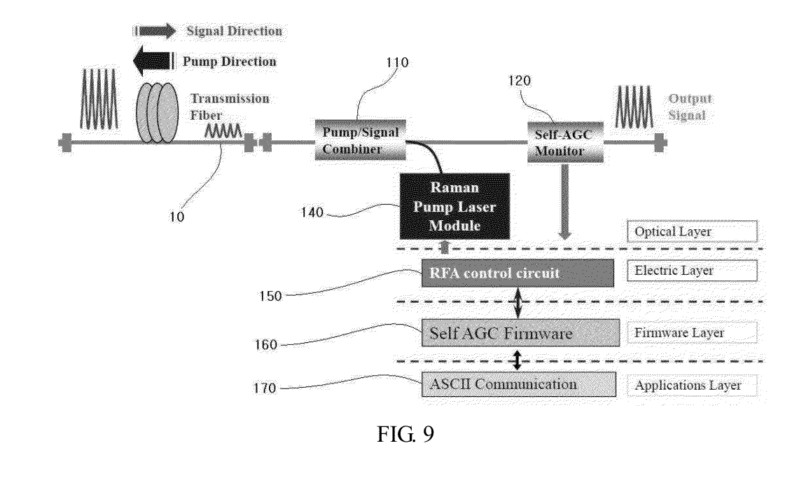

Referring to FIG. 9, a signal is transmitted to a self-AGC monitor 120 via a pump/signal combiner 110 through a transmission fiber 10 and then passes through an RFA control circuit 150, a self-AGC firmware 160, and an ASCII communication unit 170.

A Raman pump laser module 140 communicates with the RFA control circuit 150 and transmits a signal to the pump/signal combiner 110.

Specifically, the self-automatic gain control distributed Raman fiber amplifier of the present invention includes the Raman pump laser module 140 configured to generate pumping light to compensate for a signal loss which is generated from a transmission fiber, the pump/signal combiner 110 configured to input the pumping light to the transmission fiber, the self-AGC monitor 120 configured to monitor a self-AGC state and convert an optical signal into an electrical signal to be output, the RFA control circuit 150 configured to generate an electrical signal for controlling the Raman pump laser module using the electrical signal output from the self-AGC monitor 120, the self-AGC firmware 160 configured to generate a target pump laser value using a monitor signal received through the RFA control circuit 150 and transmit a control signal to the RFA control circuit, and the ASCII communication unit 170 configured to transmit or receive monitor and control information to or from an external user.

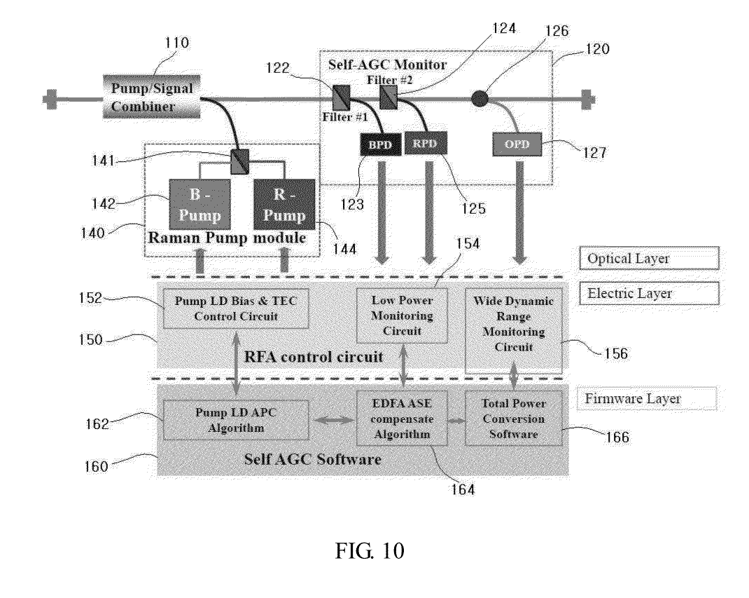

FIG. 10 is a block diagram illustrating a detailed configuration of the self-automatic gain control distributed Raman fiber amplifier shown in FIG. 9.

Referring to FIG. 10, the self-AGC monitor 120 includes a first filter 122 which is connected to a BPD 123, a second filter 124 which is connected to an RPD 125, and an OPD 127 which is connected to a tap coupler 126 of a rear part of the self-AGC monitor 120.

The first filter 122 filters some wavelengths in a short wavelength band which does not overlap with a signal light wavelength, and in detail, filters some wavelengths in a wavelength band of 1515 to 1525 nm.

The second filter 124 filters some wavelengths in a long wavelength band which does not overlap with a signal light wavelength, and in detail, some wavelengths in a wavelength band of 1567 to 1575 nm.

The Raman pump laser module 140 includes a B-pump 142, an R-pump 144, and a pump combiner 141.

The RFA control circuit 150 includes a pump LD bias & TEC control circuit 152, a low power monitoring circuit 154, and a wide dynamic range monitoring circuit 156.

The self-AGC firmware (software) 160 includes a pump LD APC algorithm 162, an EDFA ASE compensate algorithm 164, and a total power conversion software 166.

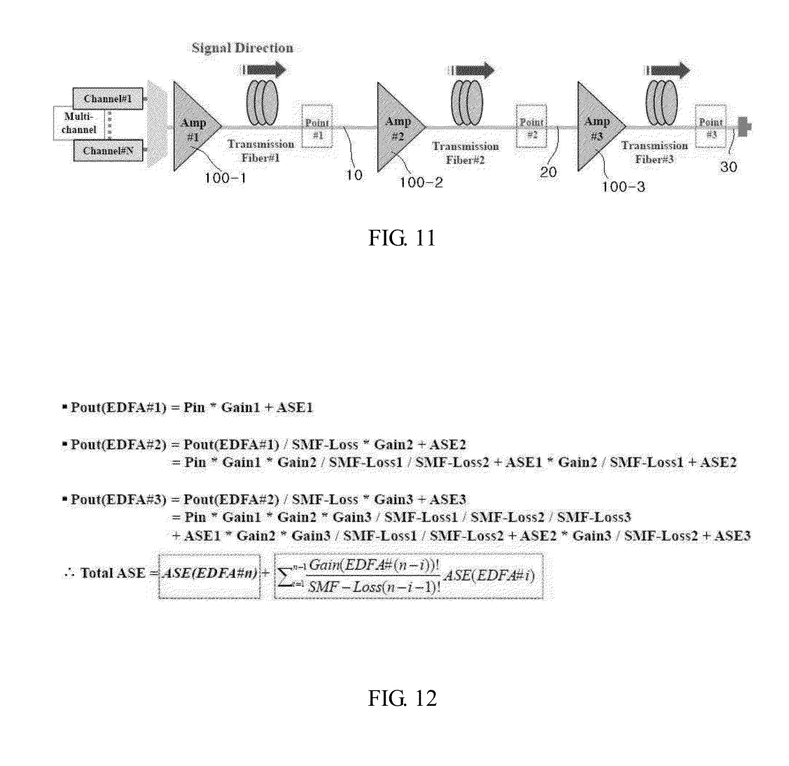

Referring to FIG. 11, according to the Raman gain error compensate algorithm of the self-AGC within an overlapping amplifier link, signals of first to N channels are output to the third transmission fiber 30 through a first amplifier 100-1 amplifying the signals of the first to N channels, a second amplifier 100-2 amplifying the signals received through the first transmission fiber 10 and outputting the amplified signals to the second transmission fiber 20, and a third amplifier 100-3 amplifying the signals which are amplified by the second amplifier 100-2 and input from the second transmission fiber 20.

In this process, each Formula and total ASE Formula are as illustrated in FIG. 12.

That is, the self-automatic gain RFA detects an ASE level, followed by starting the Raman pumping power. Therefore, a new self-AGC RFA may maintain a reference gain required within a transmission link by excluding errors of the overlapped amplifiers.

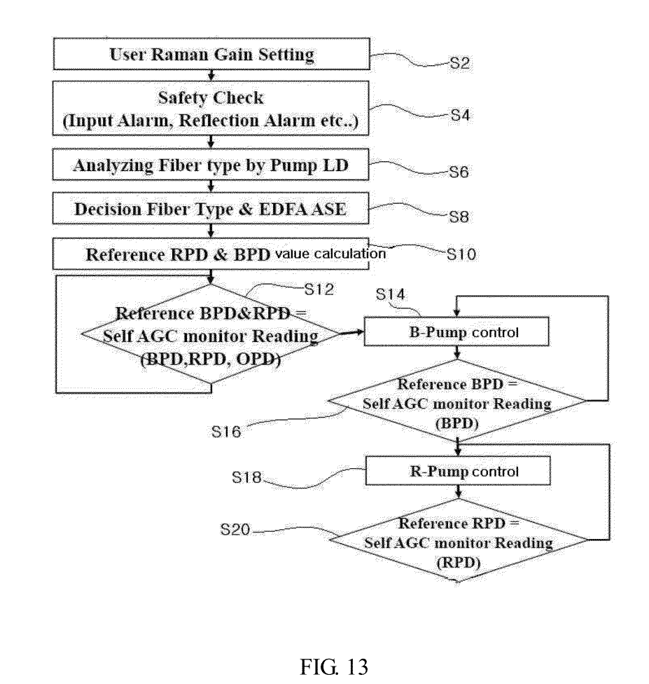

FIG. 13 illustrates a flow chart of the EDFA ASE compensate algorithm of the self-AGC. Next, an automatic gain control method of the present invention will be described with reference to FIG. 13.

First, a Raman gain of the user is set (S2). Then, safety (input alarm, reflection alarm, and the like) is checked (S4).

Next, a fiber type is analyzed by a pumping LD (S6). Next, the fiber type and the EDFA ASE are determined (S8). Reference RFD and BPD values for the target Raman gain are calculated (S10).

A process of comparing the reference RPD and BPD values with self-AGC monitor reading values (BPD, RPD, and OPD) to determine whether both values coincide with each other is performed (S12).

Next, a process of controlling the B-pump (S14), and then determining whether the reference BPD value coincides with the self-AGC monitor reading value (BPD) is performed (S16). Next, a process of controlling the R-pump (S18), and then determining whether the reference RPD value coincides with the self-AGC monitor value (RPD) is performed (S20).

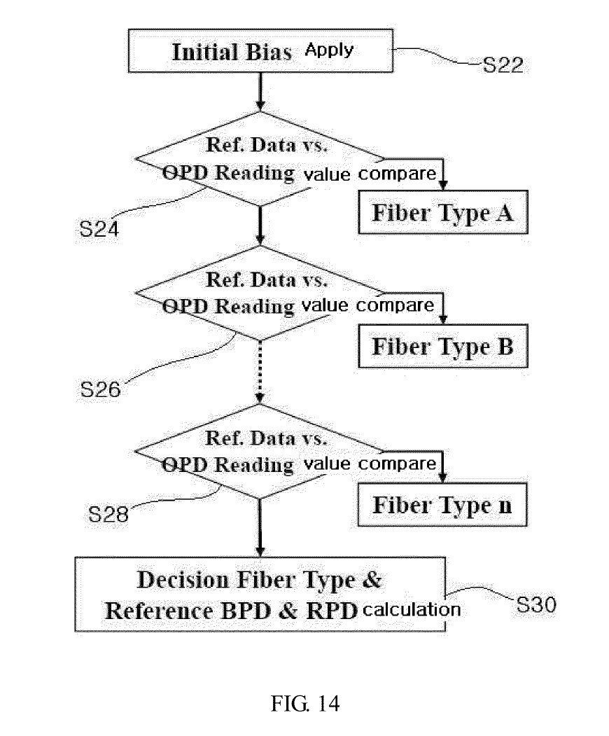

Next, the process of calculating the reference RPD and BPD by analyzing the fiber type using the pump LD will be described with reference to FIG. 14.

First, application of an initial bias set by the self-AGC RFA is started (S22).

Next, the reference data are compared with the OPD reading value (S24, S26, and S28). The fiber type is determined as A, B, and C based on the compared results, and reference RPD and BPD are calculated (S30).

According to the embodiment of the present invention, the automatic self control for maintaining the target Raman gain and the gain tilt is performed.

Further, the automatic self estimation of the Raman gain and tilt is performed.

In addition, the self compensation of the errors of the Raman gain and tilt which are caused by the cascade of amplifiers is performed.

While the present invention has been described with reference to the preferred embodiments, it will be understood by those skilled in the related art that various modifications and variations may be made therein without departing from the scope of the present invention as defined by the appended claims.

What is claimed is:

1. A self-automatic gain control distributed Raman fiber amplifier, comprising:
a Raman pump laser module configured to generate pumping light to compensate for a signal loss generated from a transmission fiber;
a pump/signal combiner configured to input the pumping light to the transmission fiber;
a self-AGC monitor configured to monitor a self-AGC state and convert an optical signal into an electrical signal to be output;
an RFA control circuit configured to generate an electrical signal for controlling the Raman pump laser module using the electrical signal output from the self-AGC monitor;
a self-AGC firmware configured to generate a target pump laser value using a monitor signal received through the RFA control circuit and transmit a control signal to the RFA control circuit; and
an ASCII communication unit configured to transmit or receive monitor and control information to or from an external user.

2. The self-automatic gain control distributed Raman fiber amplifier of claim 1, wherein the self-AGC monitor includes a first filter, a second filter, and a tap coupler, which are connected to a BPD, an RPD, and an OPD, respectively,
the Raman pump laser module includes a B-pump, an R-pump, and a pump combiner,
the RFA control circuit includes a pump LD bias & TEC control circuit, a low power monitoring circuit, and a wide dynamic range monitoring circuit, and
the self-AGC firmware includes a pump LD APC algorithm, an EDFA ASE compensate algorithm, and a total power conversion software.

3. The self-automatic gain control distributed Raman fiber amplifier of claim 2, wherein the first filter is configured to filter some wavelengths in a short wavelength band which does not overlap with a signal light wavelength, and the some wavelengths filtered by the first filter is in a wavelength band of 1515 to 1525 nm.

4. The self-automatic gain control distributed Raman fiber amplifier of claim 2, wherein the second filter is configured to filter some wavelengths in a long wavelength band which does not overlap with a signal light wavelength, and the some wavelengths filtered by the second filter is in a wavelength band of 1567 to 1575 nm.

5. An automatic gain control method for a self-automatic gain control distributed Raman fiber amplifier, comprising:
setting a Raman gain of a user;
checking safety (input alarm and reflection alarm);
analyzing, by the pumping LD, a fiber type;
determining the fiber type and an EDFA ASE;
calculating reference RPD and BPD values;
comparing the reference RPD and BPD values with self-AGC monitor reading values (BPD, RPD, and OPD) which are currently being operated to determine whether both values coincide with each other;
controlling a B-pump, and determining whether the reference BPD value coincides with the self-AGC monitor value BPD which is currently being operated; and
controlling an R-pump, and determining whether the reference RPD value coincides with the self-AGC monitor value RPD.

6. The automatic gain control method of claim 5, wherein the determining of the fiber type and the EDFA ASE includes:
starting application of an initial bias;
determining n fiber types by performing the comparison of n target OPD reading values with the current OPD reading value n times; and
completing the determining of the fiber type and the calculating the reference RPD and BPD.
